(19) United States
(12) Patent Application Publication
(10) Pub. No.: US 2015/0254650 A1
(43) Pub. Date: Sep. 10, 2015

(54) CONTROLLING TOKEN ISSUANCE BASED ON EXPOSURE

(71) Applicant: BANK OF AMERICA CORPORATION, Charlotte, NC (US)

(72) Inventors: Laura Corinne Bondesen, Charlotte, NC (US); Jason P. Blackhurst, Charlotte, NC (US); Scott Lee Harkey, Concord, NC (US); William Blakely Belchee, Charlotte, NC (US); Tammy L. Brunswig, Fort Mill, SC (US)

(73) Assignee: BANK OF AMERICA CORPORATION, Charlotte, NC (US)

(21) Appl. No.: 14/196,030

(22) Filed: Mar. 4, 2014

(51) Int. Cl. G06Q 20/36; G06Q 20/38

(52) U.S. Cl. CPC G06Q 20/3674; G06Q 20/382

(57) ABSTRACT

Embodiments described herein relate to an invention for providing a new token to a consumer for use in a pending transaction based on a determined level of exposure is provided. The systems, methods, and computer program products are configured to: (a) receive information associated with a purchase transaction involving a payment vehicle; (b) determine a potential exposure to loss based at least partially on the information associated with the purchase transaction; (c) in response to determining the potential exposure to loss, generate a token mitigating the potential exposure to loss prior to completing the purchase transaction; and (d) complete the purchase transaction based on the generated token.

### BACKGROUND

Consumers can be untrusting of the user of digital wallets and mobile devices for conducting transactions, as these consumers share a belief that using a digital wallet or mobile device form of payment are more susceptible to misappropriation and/or being compromised. Indeed, in some circumstances, the transaction information used in digital wallets and mobile devices can be compromised and used without a consumer's permission. In those circumstances, the economic exposure, alone, to the consumer can be great. And, when the compromised transaction information is tied to, or also includes, personal identifiable information of the consumer, the exposure to additional compromise or misappropriation may compound losses to the consumer. As such, a need exists for an invention that overcomes the deficiencies of the current systems and methods for transacting with a digital wallet or mobile device.

Additionally, in the circumstances or transactions that may involve some level of compromise or misappropriation, a bank of the consumer or similarly situated issuer of a payment vehicle may implement protective measures for mitigating the economic exposure of the consumer. In such a circumstance, one form of a protective measure may involve a modification of a token or a new issuance of a token for completing a potentially compromised transaction. However, it is not clear how the consumer can unwind such implemented measures. As such, a need exists for an invention that overcomes the deficiencies of the current systems and methods.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

An invention for providing a new token to a consumer for use in a pending transaction based on a determined level of exposure is provided. In some embodiments, the invention includes a computer apparatus including a processor and a memory; and a software module stored in the memory, comprising executable instructions that when executed by the processor cause the processor to: (a) receive information associated with a purchase transaction involving a payment vehicle; (b) determine a potential exposure to loss based at least partially on the information associated with the purchase transaction; (c) in response to determining the potential exposure to loss, generate a token mitigating the potential exposure to loss prior to completing the purchase transaction; and (d) complete the purchase transaction based on the generated token.

In some embodiments, the information associated with the pending purchase transaction includes any one or more of: an amount of the pending purchase transaction, identification of a payment vehicle, a previously issued token, an identification of one or more products and/or services, an identification of a merchant or parties involved in the purchase transaction, and a geographic location of the pending purchase transaction or the merchant.

In some embodiments, the invention is configured to determine the potential exposure to loss comprises: comparing the information associated with the purchase transaction to one or more historical transaction patterns associated with the payment vehicle or a holder of the payment vehicle; and determining that the pending purchase transaction is an anomaly based at least partially on the comparison.

In some embodiments, an amount of the purchase transaction, a location of the purchase transaction, a frequency of purchase transactions, or a combination thereof of the pending purchase transaction is anomalous.

In some embodiments, the invention is configured to cancel a previously issued token associated with the pending purchase transaction prior to generating the token.

In some embodiments, the generated token is different than the previously issued token, and wherein the generated token comprises instructions limiting the use of the generated token to any one or more of: transactions involving the merchant, transactions not exceeding a purchase amount, transactions in a geographic location, a limited number of purchase transactions, one purchase transaction, or any combination thereof.

In some embodiments, the invention is configured to provide to a holder of the payment vehicle a notification indicating a potential exposure to loss resulting from the pending purchase transaction.

In some embodiments, the pending purchase transaction, the determination of potential exposure to loss, and the automatic generation of a token occur in real-time or near real-time, as the pending purchase transaction is being processed.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 illustrates a system environment for using a token and entering into a transaction, in accordance with various embodiments of the present invention;

FIG. 2 illustrates a system environment for using a payment device utilizing tokens to enter into a transaction with a merchant, in accordance with various embodiments of the present invention;

FIG. 3 illustrates a system environment for using a payment device utilizing tokens in place of account information and other information of a user to enter into a transaction with a merchant, in accordance with various embodiments of the present invention;

FIG. 4 illustrates a process flow for controlling the issuance of a token based on the attributes of a purchase transaction, in accordance with various embodiments of the present invention;

FIG. 5 illustrates a system environment for controlling an issuance of tokens based on determine a potential exposure to loss in a transaction, in accordance with various embodiments of the present invention; and

FIG. 6 illustrates a process flow for restoring or reissuing a token based on user authentication, in accordance with various embodiments of the present invention.

### DETAILED DESCRIPTION

The embodiments presented herein are directed to systems, methods, apparatus, and computer program products for issuing a new token for facilitating a transaction based on a determined exposure of the transaction. As presented herein, a token is generated for facilitating a real-time or near real-time purchase transaction when it is determined that the purchase transaction increases the consumer's exposure to financial loss. In some embodiments, a system associated with a financial institution of the consumer receives a request for processing a payment from a point of sale terminal of a merchant. The system of the financial institution may evaluate the information associated with the purchase transaction, such as an amount of the purchase or a geographic location of the purchase transaction. When the system of the financial institution determines that exposure to a potential financial loss to the consumer is likely based on the information associated with the purchase transaction, the system automatically generates a token for facilitating the purchase transaction. The generated token, in this instance, is a limited token such that the limited token may only be used with a particular merchant, for amounts not exceeding a particular amount, or may be only used at a specific merchant. In this way, the exposure to financial loss to the consumer is mitigated because the token can only be used in very specific or limited situations if the payment vehicle or a previously issued token associated with a financial account of the consumer involved in the purchase transaction is compromised.

In accordance with embodiments of the invention, the term “financial transaction” or “transaction” refers to any transaction involving directly or indirectly the movement of monetary funds through traditional paper transaction processing systems (i.e. paper check processing) or through electronic transaction processing systems. Typical financial transactions include point of sale (POS) transactions, automated teller machine (ATM) transactions, internet transactions, electronic funds transfers (EFT) between accounts, transactions with a financial institution teller, personal checks, etc. When discussing that transactions are evaluated it could mean that the transaction has already occurred, is in the processing of occurring or being processed, or it has yet to be processed by one or more financial institutions. In some embodiments of the invention the transaction may be a customer account event, such as but not limited to the customer changing a password, ordering new checks, adding new accounts, opening new accounts, etc.

In accordance with embodiments of the invention, the term “filtration” or “filter” refers to the means or the process of analyzing aspects of a purchase transaction or a financial transaction to evaluate a potential exposure to loss associated with a transaction due to a number of factors including, but not limited to, a compromised payment vehicle or a compromised POS system.

In accordance with embodiments of the invention “account events” comprise any interactions that an individual, such as a customer or unauthorized user may have with an account of the customer. The account may be a financial account, digital wallet, or a customer profile account, which stores customer information, such as addresses, telephone numbers or the like. The interactions with the accounts may be direct or indirect. Indirect interaction may include an online or mobile banking session, in which the individual may not specifically interact with accounts but performs some other financial institution-related activity. As such, account event data may include, but is not limited to, data related to changing account authorization credentials, such as a user identifier and/or password; ordering/re-ordering financial products, such as checks, debit/credit card; changing payment credentials; linking one account to one or more other accounts; opening and/or closing accounts; addition and/or deletion of account users; changing customer or account-specific personal information, such as mailing address; balance inquiries and the like. In some embodiments the account events may be “non-monetary events” such that monetary events are not related to the account events, however, in some embodiments the account events may include a monetary component.

In accordance with embodiments of the invention, “account activities” refers to historical patterns in the transactions of a consumer over a period of time. For example, the “velocity” or “velocity count” is part of account activities and refers to the number of transactions or cumulative amounts of transactions associated with an account, payment vehicles, or related accounts that occurs within a specified time period; for example, eleven transactions of $50 within a day, seven transactions of $1000 or more within an hour. In other embodiments, “transaction history” is a party of account activities, and refers to the types, amounts, locations, products, or other patterns in the purchasing history of the account.

In accordance with embodiments of the invention, “geo-positioning” or “geo-caching” refers to the physical location associated with a financial transaction or account event. Geo-positioning may utilize information about the location of each transaction or account events related to one or more customer accounts. Geo-positioning may relate to each of the types of information described above (i.e., transaction information, account activities, and account events).

For example, the geo-positioning of a point of sale (POS) transaction may be the physical location of the POS, the geo-positioning of an Internet transaction may be the IP address of the user, and the like. Geo-positioning data includes: a physical address; a post office box address; an IP address; a phone number, a locality (e.g., a state, a county, a city, and/or the like); a country; geographic coordinates; or any other type of data that indicates a geographical location. The geo-positioning data can be associated with a transaction, an account event, a user, a transaction device (e.g., POS, automated teller machine (ATM), physical teller at a bank, consumer mobile device, or the like), a financial institution, a business, the location of the user's mobile device, and the like. The geo-positioning data may include, for example, a place of domicile of a user, a work location of a user, a secondary home (e.g., a vacation home), etc.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

In accordance with embodiments of the invention the terms “customer” and “user” and “consumer” may be interchangeable. These terms may relate to a direct customer of the financial institution or person or entity that has authorization to act on behalf of the direct customer, user, or consumer (i.e. indirect customer).

The present invention relates to tokenization, which is generally described in the area of financial transactions as utilizing a “token” (e.g., an alias, substitute, surrogate, proxy, stand-in, or other like identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the Internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like).

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token (e.g., provide a link or information that directs a system to a location of a token), in order to represent the specific account number during a transaction. In other embodiments of the invention, the digital wallet may store some or all of the user account information (e.g., account number, user name, pin number, or the like), including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments this may be the merchant or another third party that stores the token), and the transaction may be processed accordingly.

Specific tokens, in some embodiments, may be tied to a single user account, but in other embodiments, may be tied to multiple user accounts, as will be described throughout this application. In some embodiments a single tokens could represent multiple accounts, such that when entering into a transaction the user may select the token (or digital wallet associated with the token) and select one of the one or more accounts associated with the token in order to allocate the transaction to a specific account. In still other embodiments, after selection of the token by the user the system may determine the best account associated with the token to use during the transaction (e.g., most cash back, most rewards points, best discount, or the like). In addition, the tokens may be associated with a specific digital wallet or multiple digital wallets as desired by the institutions or users.

Moreover, the tokens themselves, or the user accounts, individual users, digital wallets, or the like associated with the tokens, may have limitations that limit the transactions that the users may enter into using the tokens. The limitations may include, limiting the transactions of the user to a single merchant, a group of multiple merchants, merchant categories, single products, a group a products, product categories, transaction amounts, transaction numbers, geographic locations, or other like limits as is described herein.

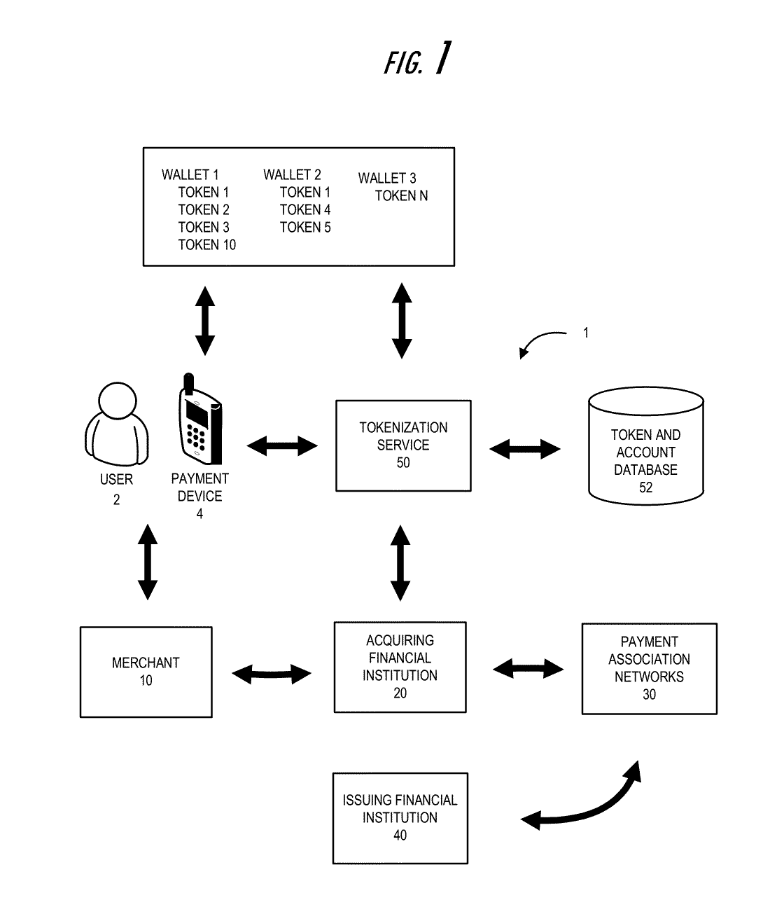

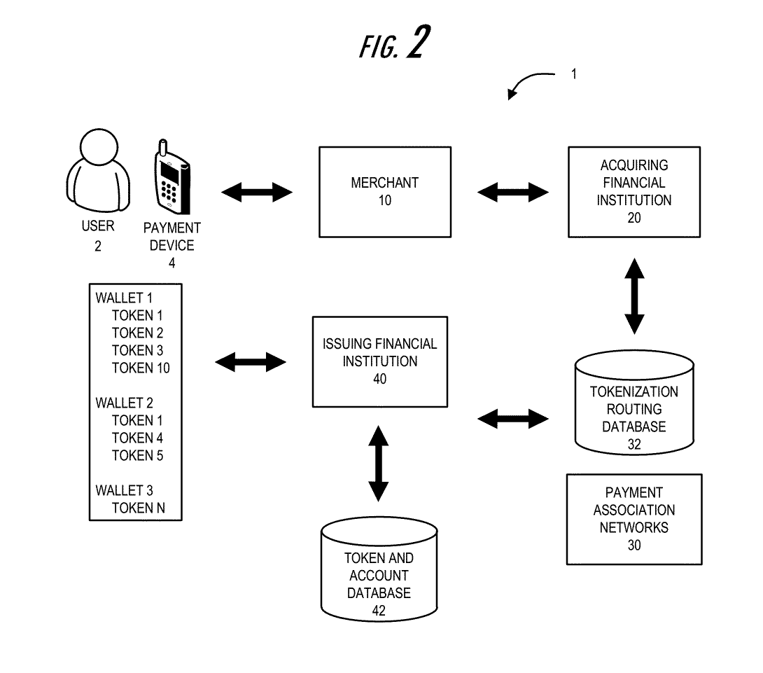

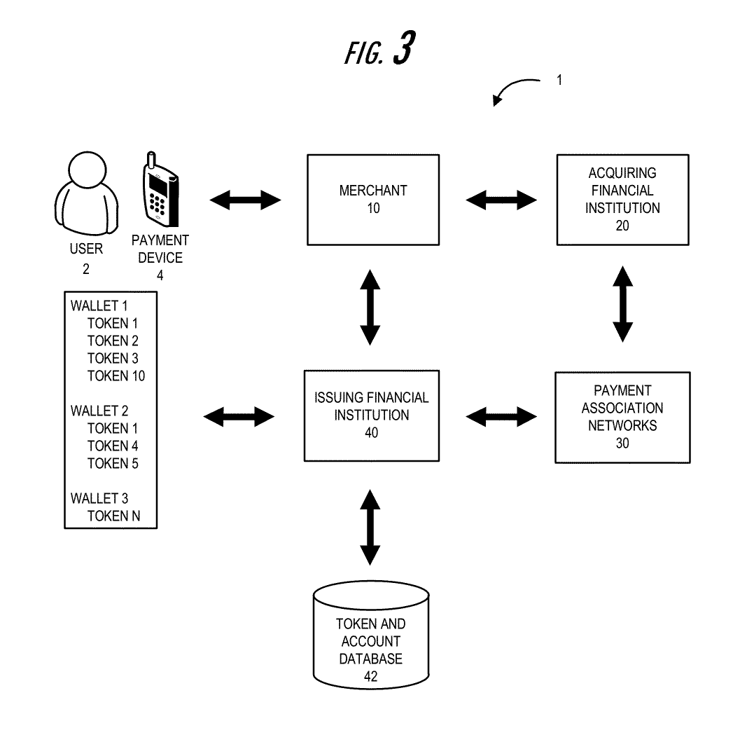

FIGS. 1 through 3 illustrate a number of different ways that the user 2 may use one or more tokens in order to enter into a transaction, as well as how the parties associated with the transaction may process the transaction. FIG. 1, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1 (as well as in FIGS. 2 and 3), a user 2 may utilize a payment device 4 (or in other embodiments a payment instrument over the Internet) to enter into a transaction. FIG. 1 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like), or other like payment devices 4. As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument (e.g., a payment application that stores the token) may be used to enter into the transaction. The payment instrument may be the same as the token or digital wallet associated with the payment device 4, except they are not associated with specific payment device. For example, the token or digital wallet may be associated with a payment application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, any other limit described herein, or the like) associated with the token that may limit the transactions in which the user 2 may enter. The limits may be placed on the token by the user 2, or another entity (e.g., client, administrator, person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described occurs when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the tokenization service indicates that the transaction meets the limits), then the acquiring financial institution 20 thereafter sends the user account number, the other user information, and the transaction information directly to the issuing financial institution 40, or otherwise indirectly through the card association networks 30. The issuing financial institution 40 determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token.

Instead of the process described above, in which the acquiring financial institution 20 requests the token from the tokenization service 50, in some embodiments the tokenization service 50 may receive the transaction request and transaction information from the merchant 10 or acquiring financial institution 20. Instead of providing the account number to the acquiring financial institution 20, the tokenization service 50 may send the transaction request and transaction information to the issuing financial institution 40 directly, or indirectly through the payment association networks 30.

The embodiment illustrated in FIG. 1 prevents the user account number and other user information from being presented to the merchant 10; however, the tokenization service 50, acquiring financial institution 20, the card association networks 30, and the issuing financial institution 40 may all utilize the actual user account number and other user information to complete the transaction.

FIG. 2 illustrates another embodiment of a token system process 1, in which the user 2 may utilize a payment device 4 (or payment instrument over the Internet) to enter into transactions with merchants 10 utilizing tokens instead of user account numbers. As illustrated in FIG. 2, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 3). In other embodiments, the issuing financial institution 40 may create the digital wallet for the user 2 (e.g., through a wallet created for a business client or retail client associated with the user 2) and include one or more tokens for various types of transactions, products, or the like. The issuing financial institution 40 may store the tokens, the associated user account information (e.g., including the user account number), and any limits on the use of the tokens, as was previously described with respect to the tokenization service 50 in FIG. 1. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with the tokens and the corresponding issuing financial institutions 40 to which transactions associated with the tokens should be routed. However, in some embodiments no customer account information would be stored in this tokenization routing database 32, only the instructions for routing particular tokens may be stored.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token, the user account associated with the token, or other limits described herein. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 2 allows the user and the financial institution to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

FIG. 3 illustrates another embodiment of the token system process 1, in which the user 2 may utilize a payment device 4 (or payment instrument over the Internet) to enter into transactions with a merchant 10 utilizing a token instead of a user account number and/or other user account information. As illustrated in FIG. 3, the user 2 may have one or more tokens associated with the payment device 2, the one or more digital wallets, or one or more user accounts within the digital wallets. The one or more tokens may be stored in the user's payment device 4 (or within the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the payment device 4 itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information to the issuing financial institution 40 directly, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system process 1 in FIG. 2, the token system process 1 in FIG. 3 allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1 through 3 are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant 10, or other institutions in the payment processing system do not have access to the actual user accounts or account information.

As briefly discussed above, if the issuing financial institution 40 creates the digital wallet not only does the issuing financial institution 40 receive transaction information along the normal processing channels, but the financial institution 50 may also receive additional transaction information from the user 2 through the digital wallet using the application program interfaces (APIs) or other applications created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the users 2 enter into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 1 through 3.

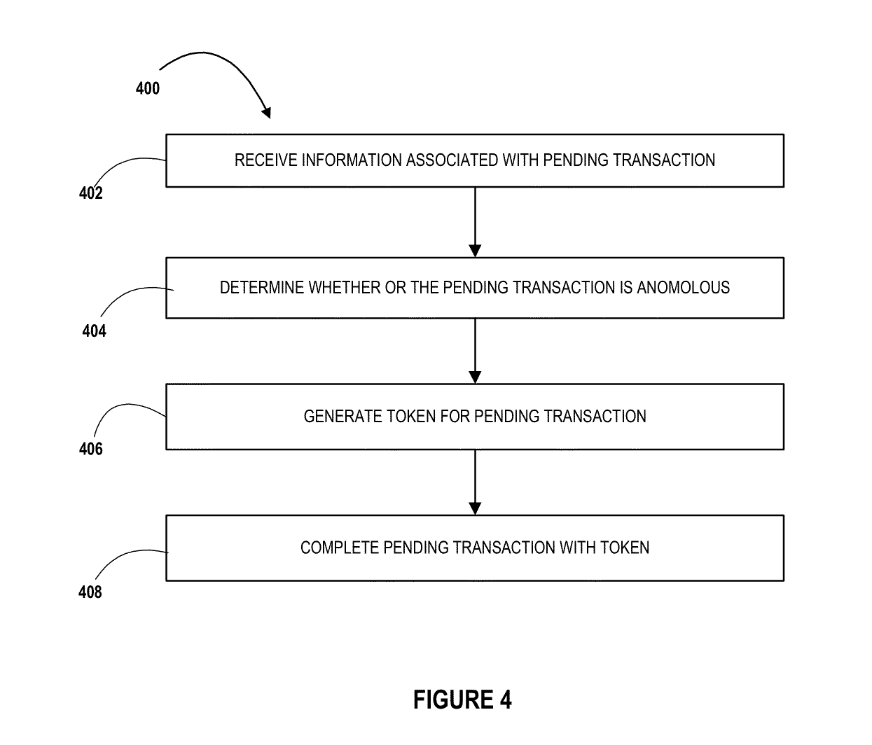

Referring now to FIG. 4, a flowchart is provided illustrating a general process flow 400 for generating and issuing a token for facilitating a purchase transaction based on a determined exposure to loss, according to embodiments of the present invention. As described, the method may comprise one or more steps, as described herein below. One or more devices, such as the one or more systems and/or one or more computing devices and/or servers of FIGS. 1-3, can be configured to perform one or more steps of the process 400 or other process described below. In some embodiments, the one or more devices performing the steps are associated with a financial institution. In other embodiments, the one or more devices performing the steps are associated with a merchant, business, partner, third party, credit agency, account holder, and/or user. As represented by block 402, a system executing process flow 400 is configured to receive information associated with a purchase transaction involving a payment vehicle of a consumer. As represented by the block 404, the system is configured to detect a potential exposure to loss based at least partially on the information associated with the purchase transaction. Further, as represented by block 406, the system is configured to in response to determining a potential exposure to loss; generate a token mitigating the potential exposure to loss prior to completing the purchase transaction. As then represented by block 408, the system is also configured to complete using the generated token the purchase transaction.

Accordingly, the system having the process flow 400 enables a financial institution or issuer of a payment vehicle to identify a potentially compromised transaction involving the payment vehicle and automatically generate a token for facilitating the transaction that limits the potential exposure to financial loss. As such, the issuer of the payment vehicle can receive transaction information in real-time, as the transaction is being processed, in order to evaluate the details of the transaction and at the same time generate the new token when the system of the issuer determines that the transaction may be compromised. In this way, a new token with substantially limited transaction capabilities is used for the potentially compromised transaction.

Initially, regarding the block 402, the phrase “information associated with the purchase transaction,” as used herein may include any information related to a transaction that is pending or has been completed involving one or more accounts or payment vehicles associated with a consumer. It will be understood that the information received may also include consumer transaction information that may broadly include any other transaction or information associated with a non-purchase or purchase transaction. For example, transaction information may be the amount of a transaction, the location of a transaction, the merchant involved in the transaction; the product (i.e., good or service) that the consumer is purchasing or has purchased in the transaction, payment information including the one or more accounts or payment vehicles associated with the transaction, the channel from which the transaction is received, and the like. In some embodiments, payment information includes information, such as consumer account numbers, PINs, tokens, payment vehicles, and/or other consumer and account identifiers, is entered by the consumer and/or cashier using a mobile device or digital wallet or by swiping a transaction card (e.g., bankcard, credit card, or the like), scanning some other machine-readable code associated with the consumer or consumer's financial account, and/or manually entering information into an input device, such as a keypad or touchpad.

Further, the term “payment vehicle,” as used herein, may refer to any of, but is not limited to refers to any of, but is not limited to, a physical, electronic (e.g., digital), or virtual transaction vehicle that can be used to transfer money, make a payment (for a service or good), withdraw money, redeem or use loyalty points, use or redeem coupons, gain access to physical or virtual resources, and similar or related transactions. For example, in some embodiments, the payment vehicle is a bank card issued by a bank which a customer may use to perform purchase transactions. However, in other embodiments, the payment vehicle is a virtual debit card housed in a mobile device of the customer, which can be used to electronically interact with an automated teller machine (ATM) or the like to perform financial transactions. Thus, it will be understood that the payment vehicle can be embodied as an apparatus (e.g., a physical card, a mobile device, or the like), or as a virtual transaction mechanism (e.g., a digital transaction device, digital wallet, a virtual display of a transaction device, or the like).

As illustrated at block 402, it will be understood that the system having the process flow 400 can be configured to receive information associated with the purchase transaction involving a payment vehicle. In some embodiments, the information associated with the purchase transaction is received from a point-of-sale (POS) terminal during a transaction involving a consumer and a merchant. For example, a consumer checking out at a retail merchant, such as a grocer, may provide to the grocer the one or more goods or products that he is purchasing together with a payment method, loyalty card, and possibly personal information, such as the name of the consumer. This information along with information about the merchant may be aggregated or collected at the POS terminal and routed to the system or server of the present invention or otherwise a third party affiliate of an entity managing the system of this invention. In other embodiments when the purchase transaction occurs over the Internet, the information associated with the purchase transaction is collected at a server providing an interface for conducting the Internet transaction. In such an embodiment, the consumer enters product, payment, and possibly personal information, such as a shipping address, into the online interface, which is then collected by the server. The server may then aggregate the transaction information together with merchant information and route the transaction and merchant information to the system of the present invention. It will be further be understood that the information associated with the purchase transaction may be received from any channel such as an automated teller machine (ATM), Internet, peer-to-peer network, POS, and/or the like.

Regarding the block 404, the term “potential exposure to loss,” as used herein, refers to any of, but is not limited to, the possibility of economic loss (e.g., financial loss), the possibility of a loss of data (e.g., personally identifiable information and the like), a possibility of a loss of access, a possibility of a compromised payment vehicle or information associated with a payment vehicle, and/or the like.

Further regarding the block 404, it will be understood that the system having the process flow 400 can be configured to determine a potential exposure to loss in a number of ways. Once the information associated with the purchase transaction is received, the system may then analyze the information for determine a potential exposure to loss. For example, in some embodiments, the system is configured to determine or identify certain events that may cause a loss and thus act as triggering events for initiating one or more processes for protecting the customer from loss. For example, in some embodiments, the system is configured to determine that the payment vehicle is compromised based on a series of unusual transactions involving the payment vehicle. In such a circumstance, upon detecting the unusual transactions involving the payment vehicle, the system may automatically initiate processes for cancelling a previously issued token and generating or issuing a new token having limited transaction capabilities. In another example, in some embodiments, the system is configured to receive a manual or automated notification of unusual activity from a merchant or other third party (e.g., individual who finds lost transaction card, or the like) which would then trigger customer protection processes by the system. In yet another example, in some embodiments, the transaction card is a smart card that can be geographically located based on integrated global or local tracking technology or the like and the system is configured to determine that the transaction card is compromised or misplaced based on a determined location of the transaction card.

Still regarding block 404, the system having process flow 400 may implement a misappropriation or compromised payment vehicle filtering process that identifies anomalous occurrences indicating a likelihood of an exposure to loss. The filtering process may include multiple levels of filtration including a first level and a second level of filtration. The first level of filtration may filter information associated with the purchase transaction and other historical transaction information associated with a payment vehicle of the consumer to determine whether the amount of the purchase transaction conforms to the historical transaction patterns. The system may determine whether or not the amount of the purchase transaction conforms to the historical transactions patterns in a number of methods.

In some embodiments, a first method may involve, initially determining transaction amount thresholds based on the transaction historical of the payment vehicle involved in the purchase transaction. For example, based on using the first method, the system may determine that normally transaction amounts using the payment vehicle does not exceed $500 and that the average transaction amount for the payment vehicle is $225. In this way, the system determines, at least two thresholds, a maximum transaction amount and average transaction amount based on the transaction history of the payment vehicle, where the maximum transaction amount represents the highest transaction amount value over a defined period of time. Still, using the first method, the system may then compare the amount of the purchase transaction to both the average transaction amount of $225 (1^{st} threshold) and maximum transaction amount of $500 (2^{nd} threshold). Such that when, in some embodiments, the amount of the purchase transaction exceeds the 1^{st} threshold a first indication of potential/likelihood of exposure to loss is determined. And when, in some embodiments, the amount of the purchase transaction exceeds the 2^{nd} threshold a second indication of potential/likelihood of exposure to loss determined. The indication of potential/likelihood of exposure to loss may be scaled such that as the amount of the purchase transaction exceeds an increasing number of thresholds, the potential or likelihood of loss also increases (e.g., exceeding 1^{st}=40% chance of loss, exceeding 2^{nd}=60% chance of loss, exceeding 3^{rd}=85% chance of loss, and the like). It will be understood that the system should not be limited by the above example and that the system may have an unlimited number of thresholds for determining the potential of exposure to loss.

Of note, the filtration used to determine potential of exposure to loss of a purchase transaction is not necessarily the singular analysis of a single attribute (such as a transaction amount), but may be a low-level analysis of one or more of a plurality of attributes. Indeed, the filtration may analyze at least one of a plurality of attributes such as, but not limited to, the amount, the payee, the location, the channel, the date and/or time, velocity data, non-monetary account changes data, token usage data, and the like of a transaction, and thereafter other stages of filtration may or may not be utilized to further filter other attributes of the transaction that may lead to financial loss using one or more of the attributes described herein. For example, the frequency and/or velocity of transactions may also be analyzed in a similar manner, such that the transaction history of the payment vehicle involving in a purchase transaction is used to determine a first threshold and a second threshold to be used in determining the potential of exposure to loss.

A second method of determining a potential exposure to loss involves first identifying historical transaction patterns associated with a payment vehicle involved in a purchase transaction. Second, associating one or more standard deviations from the mean for each historical transaction pattern with a different likelihood or potential of exposure to loss. So that, when an amount of the purchase transaction or a velocity of the purchase transactions associated with the purchase vehicle meets or exceeds standard deviations from the mean of the historical transaction pattern, a probability or percentage value of potential for exposure may be determined (e.g., meet or exceed 1^{st} st. dev.=35%, meet or exceed 2^{nd} st. dev.=55%, meet or exceed 3^{rd} st. dev.=80%, and the like).

A third method of determining a potential of exposure to loss involves first identifying historical transaction patterns associated with a payment vehicle involved in a purchase transaction. Second, comparing an amount of a purchase transaction to the pattern and determining that a meaningful potential of exposure to loss exists when the amount of the purchase transaction falls outside of the historical transaction pattern. For any of the above described methods for determining a potential of exposure to loss, the system may determine an outliers or purchase transactions that fall outside of the thresholds or patterns to be anomalous.

As illustrated at block 406, once a purchase transaction is identified as anomalous or a determination of a potential of exposure to loss, the system executing process flow 400 generates a token for facilitating the purchase transaction. It will be understood that the token may be generated automatically, in real-time or near real-time, immediately after a determination of potential loss is made (e.g., within moments, seconds, or a minute, or the like), as the purchase transaction is being processed. For example, while a user is checking out at a POS terminal during a pending purchase transaction, the system of the present invention may determine a potential exposure to loss. In such an example, during the pending purchase transaction, the system generates a new token for facilitating the pending purchase transaction.

Still regarding block 406, the token generated by the system for facilitating the transaction may be a restricted or limited token that mitigates the exposure to loss. The token may be limited in a number of ways and the limitations and restrictions of the token may be based at least in part of the attributes of the purchase transaction or other circumstances involving the purchase transaction or payment vehicle involved in the purchase transaction. Thus, in some embodiments, upon identifying an anomalous purchase transaction based on a large purchase amount, the system may generate a token that limits the purchasing power of the payment vehicle that is tied to the token. For example, the system of the present invention may identify an amount of a purchase transaction of $500, which exceeds an average transaction amount of $125 of the bank card involved in the purchase transaction. In such an example, the system automatically generates a token that limits the purchase power of the bank card to $550 so that if the purchase transaction involves a compromised bank card or involves misappropriation, the maximum exposure using the bank card is $550. Further, in such an example, the bank card of the consumer prior to the anomalous purchase transaction may have had purchasing power of up to $10,000. However, the system generated token modifies the attributes and features associated with the bank card so that the purchasing power is reduced to $550 based on identifying an anomalous transaction involving the bank card. In some embodiments, the purchasing power of the bank card is not restored until the owner or holder of the bank card fully authenticates himself or communicates with the issuer of the bank card to provide sufficient rationale that explains the anomalous transaction.

In some embodiments, the generated token comprises computer-executable instructions or code and other information for modifying one or more attributes of a payment vehicles. As described above, the instructions or code may limit the purchasing power (e.g., available funds or available credit) of a payment vehicle. Additionally or alternatively, the instructions may further limit the geographic locations at which the payment vehicle may be used, the merchants and merchant locations at which the payment vehicle can be used, and the like. Similarly, the instructions or code may convert the payment vehicle from an unlimited use to a limited use payment vehicle. For example, the payment vehicle may initially be identified as a credit card, which is a revolving account with unlimited use. However, based on determining that the credit card is being used in an anomalous transaction the system may generate a token that limits the use of the credit card to two or three overall transactions so that the potential for loss is limited to those two or three transactions if it is subsequently determined that the payment vehicle was compromised or the transactions involved misappropriation. It will be understood that the generated token can be used to modify any attribute of a payment vehicle and not only the examples described herein. As an example, the generated token may alter a bank card of a consumer such that it can only be used at certain times of the day. This modification may be made in combination with several other modifications including modifying the available credit or available funds of a payment vehicle, the permissible merchants at which the payment vehicle may be used, the permissible geographic locations at which the payment vehicle may be used, and the like.

Further still regarding block 406, in some embodiments, prior to generating a new token, the system cancels a previously issued token associated with a payment vehicle involved in an anomalous transaction. Therefore, in some embodiments, there is a first token which is being used to initially facilitate the purchase transaction. However, when the system determines that the purchase transaction is anomalous, the first token is suspended, cancelled, or otherwise made inoperable by the system. In this embodiment, the system generates a new token during the purchase that comprises different instructions or code than the first token. In many embodiments, the generated second token is a limited or restricted token as compared to the first token. The first token therefore may provide general usage attributes to the payment vehicle, whereas the second token reduces the attributes or otherwise modifies the attributes of the payment vehicle so that the usage of the payment vehicle having the second token is diminished when compared to the payment vehicle having the first token. It will be understood that, in some embodiments, the system may not issue a new second token but instead, modifying the first token or the previously issued token associated with the payment vehicle to a limited or restricted token.

As illustrated at block 408, once the token is generated and received by the system, the purchase transaction may be automatically processed to completion. In this way, even if the system determines that there is a likelihood or potential of exposure to loss, the purchase transaction is still completed using the generated token. In this way, the purchase transaction is not denied at the POS terminal or otherwise. However, the ability of the user of the payment vehicle to conduct a transaction may be severely curtailed.

Still at block 408, contemporaneously or some time before or after the completion of the purchase transaction, the system having process flow 400 provides a notification to the user indicating that a token was generated for the transaction based on determining that the purchase transaction involved a heightened potential exposure to loss. In some embodiments, the notification further includes instructions for restoring a previously issued token to a payment vehicle or instructions for issuing another token that does not have the limitations or restrictions of the generated token.

It will further be understood that the system having the process flow 400 can be configured to perform any of the portions of the process flow 400 represented by blocks 402-410 upon or after one or more triggering events (which, in some embodiments, is one or more portions of process flow 400). As used herein, “triggering event” refers to an event that automatically triggers the execution, performance, and/or implementation of a triggered action, either immediately, nearly immediately, or sometime after (e.g., within minutes, etc.) the occurrence of the triggering event. For example, in some embodiments, the system having process flow 400 is configured such that the system receiving an indication of a compromised payment vehicle or a potential exposure to loss (the triggering event) automatically and immediately or nearly immediately triggers the system to automatically (without human intervention) generate a token for facilitating or completing a pending purchase transaction (the triggered action).

Also it will be understood that, in some embodiments, a predetermined time and/or the passage of a predetermined period of time may serve to trigger one or more of the portions represented by the blocks 402-410. It will also be understood that, in accordance with some embodiments, the system having the process flow 400 is configured to automatically perform one or more of the portions of the process flow 400 represented by the blocks 110-150, whereas in other embodiments, one or more of the portions of the process flow 400 represented by the blocks 402-410 require and/or involve human intervention. Of course, in addition to the system having the process flow 400, it will be understood that any of the embodiments described and/or contemplated herein can involve one or more triggering events, triggered actions, automatic actions, and/or human actions.

In addition, it will be understood that, in some embodiments, the system having the process flow 400 (and/or a user thereof) is configured to perform each portion of the process flow 400, from start to finish, within moments, seconds, and/or minutes (e.g., within approximately 10-15 minutes, etc.). In some embodiments, the system having the process flow 400 can be configured to perform one or more portions of the process flow 400 in real time, in substantially real time, and/or at one or more predetermined times. Further, it will be understood that the number, order, and/or content of the portions of the process flow 400 are exemplary and may vary. It will further be understood that the system having the process flow 400 can be configured to perform any one or more of the portions of any one or more of the embodiments described and/or contemplated herein.

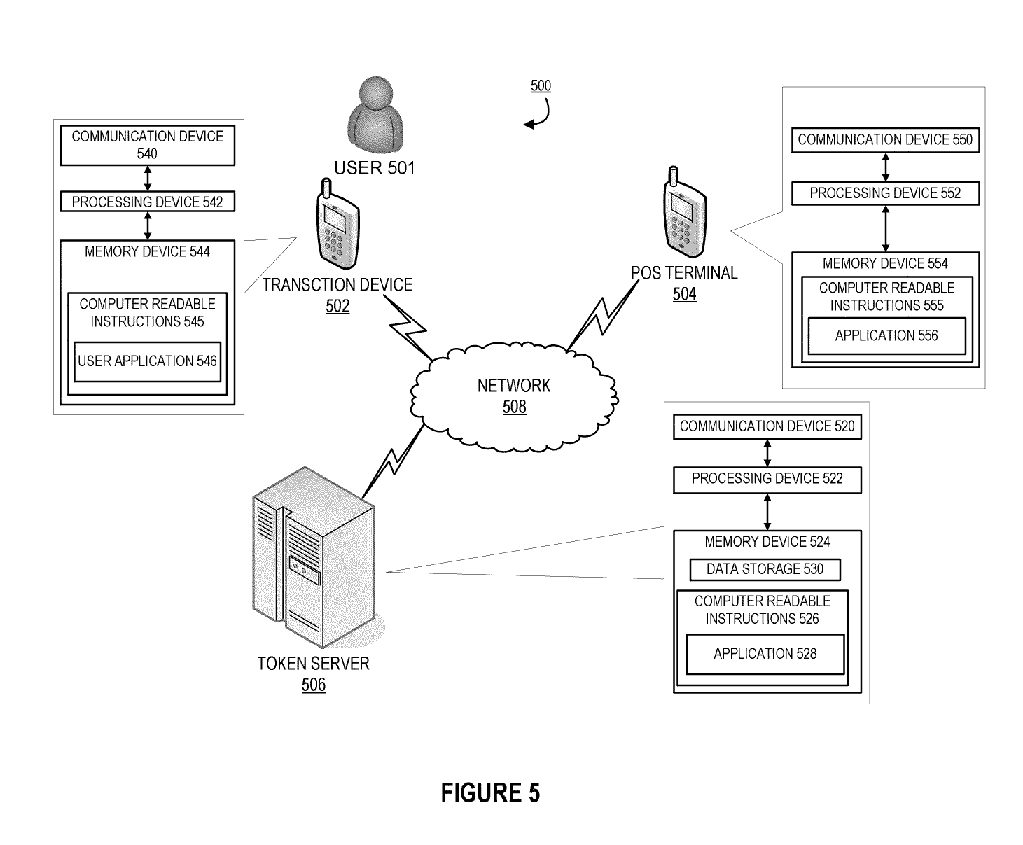

Referring now to FIG. 5 illustrates a system environment 500 for controlling an issuance of a token based on a determined exposure to loss in a consumer transaction, in accordance with an embodiment of the invention. As illustrated in FIG. 5, the system environment 500 includes a transaction device 502, a point-of-sale (POS) terminal 504, a token server 506, and a network 508. The transaction device 502 is in operable communication with the POS terminal 504 and the token server 506 via the network 508. In this way, the transaction device 502 may send and receive information from both the POS terminal 504 and the token server 506. The transaction device 502 is associated with user 501 and may be any kind of device used in a transaction including a mobile device or a physical transaction card. As used herein, a “mobile device” is any mobile communication device, such as a cellular telecommunications device (i.e., a cell phone or mobile phone), personal digital assistant (PDA), a mobile Internet accessing device, or other mobile computing device. Additionally, the token server 506 may include one or more servers that are maintained by a financial institution of user 501 or a third party affiliate of the financial institution.

The network 508 may include a local area network (LAN), a wide area network (WAN), a global area network (GAN), near field communication network, bluetooth network or any other type of communications network or protocol. In some embodiments, network 508 may comprise the Internet. In addition, network 508 may include first, second, third, and/or fourth-generation cellular communication networks and/or the like. For example, the network 508 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 508 may provide for wireline, wireless, or a combination of wireline and wireless communication between devices in the network.

In some embodiments, network 508 may be a near field communication (“NFC”) network, cellular network, and/or Internet. In this way, the transaction device 502 may communicate with the POS terminal 504 using the NFC network, cellular network, of Internet. As an example, transaction device 502 may communicate via an NFC interface with POS terminal 504 in order to complete a transaction. In some embodiments, transaction device 502 transmits via the NFC interface a token to the POS terminal as payment for the transaction.

The POS terminal 504 may be a payment terminal, such as a register, or a mobile payment terminal. The POS terminal 504, in some embodiments, communicates via network 508 with the token server 506 in order to validate a token received from transaction device 502 during a transaction.

The POS terminal 504 generally comprises a communication device 550, a processing device 552, and a memory device 554. The processing device is in operable communication with communication device 550 and the memory 554. The processing device 552 may send or receive data from the POS terminal 504 to the token server 506 via the communication device 550 over the network 508. As such, the communication device 550 generally comprises a modem, server, or other device for communication with the other devices on the network 508.

Further, POS terminal 504 comprises computer-readable instructions 555 of an application 556. In some embodiments, the application 556 allows the POS terminal 504 to be linked to the token server 506 to communicate via a network 508. The application 556 may also allow the transaction device 502 to connect directly with the POS terminal 504 for proximity services (e.g., using either cellular based links or non-cellular based links. The application 556 may receive and communicate tokens by performing one or more of the steps describe herein.

The token server 506 generally comprises a communication device 520, a processing device 522, and a memory device 524. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device.

The processing device 522 is in operable communication with the communication device 520 in order to communicate with the network 508 and other devices on the network 508. As such, the communication device 520 generally comprises a modem, server, or other device for communicating with other devices on the network 508.

The token server 506 comprises computer readable instructions 526 of an application 528. In some embodiments, the memory device 524 includes data storage 530 for storing data related to and/or used by the application 528. The application 528 may perform generating, cancelling, communicating, or authenticating a token by performing one or more of the steps described herein.

The transaction device 502 comprises generally comprises a communication device 540, a processing device 542, and a memory device 544. The processing device 542 is operatively coupled to the communication device 540 and the memory device 544. In some embodiments, the processing device 542 may send or receive data from the transaction device 502, to the token server 506 via the communication device 540 over a network 508. As such, the communication device 540 generally comprises a modem, server, or other device for communicating with other devices on the network 508.

Additionally, the transaction device 502 comprises computer readable instructions 545 stored in the memory device 544, which in some embodiments includes the computer-readable instructions 545 of an application 546. In some embodiments, the application 546 allows the transaction device 502 to be linked to the transaction server 506 to communicate, via a network 508. The application 546 may also allow the transaction device 502 to connect directly (i.e. locally or device to device) with the POS terminal 504 for proximity services (e.g. using either cellular based links or non-cellular based links). The application 546 may be configured to receive, store in the data storage 548, and communicate tokens by performing one or more of the steps described herein.

In general, following a determination of potential misappropriation or compromise in a transaction involving a payment vehicle or mobile wallet of a user, an issuer or a financial institution of the user may restrict use of the payment vehicle or mobile wallet by limiting or modifying a token associated therewith. In the instances, when the financial institution or issuer of the token has modified or issued a limited token based on the potential compromise in the transaction, the present invention provides the user an opportunity to authenticate himself or herself or the transaction in order to restore the capabilities of the token or otherwise reissue an unfettered token. In use, a notification may be provided to a user via a mobile device with instructions or steps for restoring or reissuing a token. And, based on a successful authentication, the present invention may restore some or all of the functions of a token or reissue a token with added functionality. In the instance that an unsuccessful authentication is received, the invention may escalate limitations associated with the limited token or cancel the usage of the limited token for conducting transactions until a heightened level of authentication from the user is provided.

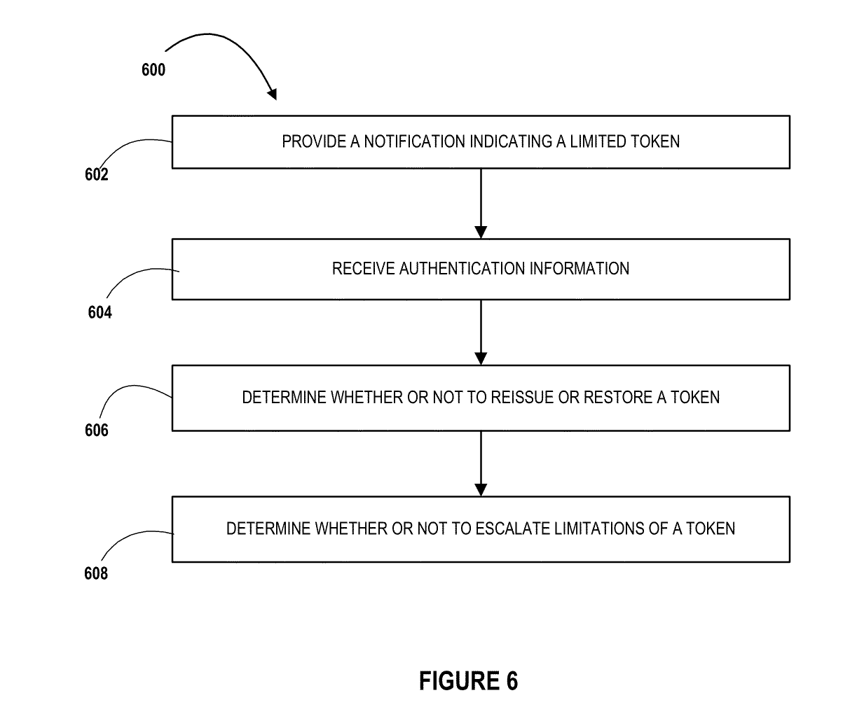

Referring now to FIG. 6, FIG. 6 provides a flowchart illustrating a general process flow 600 for restoring or reissuing a token based on an authentication of a user or an authentication of a transaction. As described, the method may comprise one or more steps. One or more devices, such as the one or more systems and/or one or more computing devices and/or servers of FIGS. 1-5, can be configured to perform one or more steps of process flow 600. As represented by block 602, a system executing process flow 600 is configured to provide to a user a notification indicating that a token was modified or generated for a previously completed transaction involving a potential exposure to loss. As represented by block 604, a system executing process flow 600 is configured to receive from the user authentication information. As then represented by the block 606, a system executing process flow 600 is configured to determine whether or not to reissue a token or restore a previously modified or fettered token based at least partially on the authentication information. As represented by the block 608, a system executing process flow 600 is configured to determine whether or not to escalate limitations of a token or cancel usage of the token based at least partially on an unsuccessful authentication. Lastly, as represented by the block 610, a system executing process flow 600 is configured to restore a previously modified token or reissue an unfettered token.

Accordingly, the system having the process flow 600 enables a financial institution or issuer of a payment vehicle to quickly restore usage of the payment vehicle by restoring a token associated with the payment vehicle or reissuing a token to the payment vehicle having increased or unmodified functionality. In this way, the consumer having the payment vehicle may continue to use the payment vehicle without any additional limitations due to the previously completed transaction having a potential exposure to loss.

Referring now to the block 602, it will be understood that the system having the process flow 600 can be configured to provide a notification indicating a modification limiting a token associated with a payment vehicle or a new token with diminished capabilities was issued to the payment vehicle. The notification may be provided to a user associated with the payment vehicle in a number of ways including, but not limited to, via a mobile computing device (e.g., via phone call, text message, e-mail, software application housed on the phone, and the like), via an online banking account, via in-person branch banking, and/or the like. In some embodiments, the notification comprises information associated with and an identification of a transaction triggering the modification or issuance of the token. In such an embodiment, the information associated with the transaction may include transaction details including products or services purchased, time and date of the transaction, location of the transaction, a merchant involved in the transaction, an amount of the transaction, and/or the like.

Still regarding the block 602, additionally, in some embodiments, the notification may be provided to an online banking account of a user. In such an embodiment, an indicator may be associated with a transaction that triggered the notification. The indicator may be proximate to (e.g., side-by-side, next to, or around, and the like) the transaction triggering the notification or forms of a part of the transaction record of the transaction triggering the notification. The indicator may be presented via the online banking account in a number of ways including, but not limited to, in an audible form or recording, as a visual element (e.g., a red flag, highlighting, underlining, and/or the like), a signal indicator, and/or otherwise. The indicator may be any form or element that distinguishes the transaction that triggers the notification from other transactions or other portions of the interface of the online banking account. In some embodiments, the indicator or the transaction is selectable by the user. In this way, upon selecting the indicator and/or the associated transaction, information associated with the notification may populate in the window, in a new window/tab, a pop-up window, or the like and is readily ascertainable to the user. It will be understood that the information associated with the information may also be immediately visible to the user upon logging into to the online banking interface and may be positioned prominently thereon. As such, the information associated with the notification may be positioned in any location on the online banking interface including on the center of the interface, proximate to the associated transaction triggering the notification, and the like.

Moreover, in some embodiments, the notification comprises instructions for or one or more processes for restoring a token or reissuing an unfettered token to be associated with a payment vehicle of the user. The instructions or one or more processes associated with the notification may include a request to authenticate a user of a mobile wallet, a payment vehicle, or to authenticate the transaction triggering the notification. In some embodiments, the request comprises a prompt for a user name/password combination, a PIN code, a password, biometric authentication, and/or the like. In one aspect, the level of authentication may depend on the scope and nature of the potential exposure to loss associated with the transaction triggering the notification and request for authentication.

Regarding the block 604, it will be understood that the system having the process flow 600 can be configured to receive authentication information from a user. Authentication information, as referred to herein, may include any information that may be used to verify, identify, or otherwise determine an identity of an individual or entity. As an example and as previously describe above, authentication information may include a PIN code or a password. The authentication information may be received via a number of channels available to the user including via a mobile banking application housed on a mobile device of a user, via online banking, via an automated teller machine (ATM), via in-person branch banking, via a telephone call, and/or the like. It will be understood that the authentication information may be received by the system in any number of ways and shall not be limited to the examples above.

Additionally, still regarding block 604, the system may be configured to receive an indication or instructions from the user regarding whether to reissue an unfettered token or to restore the modified to token. In some embodiments, the instructions from the user may be received in combination with the authentication information. In one example, in some embodiments, the request for authentication information from the user also includes a request for a selection of whether to reissue an unfettered token or to restore the modified token. It will be understood that the notification may include multiple requests for information and similarly, a system executing the processes of the present invention may be configured to receive one or more types of information from the user.

As represented by the block 606, it will be understood that the system having process flow 600 can be configured to determine whether or not to reissue a token or restore a token based at least partially on the authentication information and/or instructions from the user. In one aspect of the present invention, the system is configured to determine whether or not the authentication information received from the user successfully authenticates the user and/or the transaction. When it is determined that the authentication information is successful, the system may automatically generate an unfettered token for issuance to the user or automatically restore the modified token to an original state prior to being modified based on determining a potential exposure to loss in a transaction involving the token. As an example, upon receiving a username and password for authenticating the identity of a user, the system is configured to compare the username and password to stored username and password values for that user. When the received username and password value matches the stored values, the system may automatically reissue a new token or restore a previously modified token. Alternatively, if the received username and password values do not match, the system may not reissue a token to the user or restore the previously modified token.

As represented by the block 608, either in addition to or alternatively to the processes in block 606, the system having process flow 600 can be configured to determine whether or not to escalate limitations of the fettered token or modified token currently associated with the payment vehicle or mobile wallet of the user based at least partially on the authentication information. In some embodiments, when it is determined that the authentication information is unsuccessful, the system may automatically augment or increase the limitations associated with the fettered or modified token. For example, a token is modified to limit the credit limit associated therewith from $10,000 to $500. However, in an attempt to unlock the full credit limit associated with the payment vehicle, a user may provide authentication information to the system. If the system determines that authentication information provided by the user is unsuccessful or incorrect, then the system may potentially escalate the limitations associated with the payment vehicle by further limiting the usage of the token. In such an example, the system may further reduce the credit limit associated with the token from $500 to $50 in order to provide additional protections against potential misappropriation or compromise. In addition, if there is an unsuccessful authentication, the user may be required to provide a heightened level of authentication. For example, the level off authentication may be heightened from including only a passcode to subsequently involving a passcode and some biometric authentication (e.g., voice authentication, fingerprint, and/or the like). It will be understood that the authentication requirement can be heightened to any level in order to protect the customer.

Lastly, as represented by the block 610, the system having process flow 600 can be configured to restore a previously limited or modified token or generate an unfettered token. In some embodiments, the system is configured to restore a modified token to an original state of the token prior to an anomalous transaction or event triggering the modification to the token. For example, an original state of a modified token may be a first state in which the token is issued to a user having a payment vehicle, such as a credit card. The credit card may have a credit limit of $500 and may be used generally for providing payment in a transaction involving any merchant. The issuing bank may provide or associate a token for the payment vehicle for allowing the user to conduct a transaction with the payment vehicle while protecting personally identifiable information associated with the credit card, such as the credit card number and the name of the cardholder. In such an example, the token comprises instructions indicating that the associated payment vehicle has a credit limit of $500 and that the credit card can be used at any merchant. However, in some embodiments, upon an occurrence of an anomalous transaction involving the payment vehicle, the bank issuing the token may modify the token to limit the usage of the credit card to mitigate the potential exposure to loss. As such, the token is modified to include instructions or otherwise indicating that credit limit of the card is now or has been changed to $50 and that the card can only be used at one or more specific merchants. It will be understood that although the token may include instructions changing the credit limit of the credit, the bank issuing the credit card may or may not actually change the credit limit of the credit, but instead, only the instructions associated with the token is changed to indicate a new credit limit and any other limitations. It will further be understood that the token can be modified to limit the ability to transact with the payment vehicle in any numbers of ways and should not be limited to the example(s) provided herein. Continuing with the example, in order to restore the token to its original state, the bank may change the instructions or code associated with the token to now indicate that the credit limit of the payment vehicle is $500 and that the payment vehicle may be used at any merchant. Thus, restoring the credit limit from $50 to $500 and lifting the merchant limitations.

Similar to the processes involved in the restoration of a modified token, the system may be configured to implement similar steps or processes in order to generate or reissue a new token that is unfettered. In some embodiments, the system is configured to identify one or more features of a payment vehicle or an original token associated with the payment vehicle. These one or more features may include an original credit limit, an expiration date, a geographic scope for transacting, limitations to merchants with which a transaction may be conducted, and/or the like. As an example, one or more original features associated with a payment vehicle or token may include a $500 credit limit and no limitations on merchants at which a transaction may be conducted. In some embodiments, information identifying the one or more features of the payment vehicle or associated token is stored by the bank or entity issuing the token or payment vehicle. Once the system identifies the one or more features of a token in an original state and/or the payment vehicle, the system is configured to generate a new token that is unfettered and having the one or more identified features.

The embodiments of the disclosure may be embodied as a system, method, or computer program product. Accordingly, aspects of the present disclosure may take the form of an entirely hardware embodiment, an entirely software embodiment (including firmware, resident software, micro-code, and the like) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, and the like, or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. Thus, although not expressly described, any or each of the features of the invention disclosed herein may be combined in any manner. The following claims are in no way intended to limit the scope of embodiments of the disclosure to the specific embodiments described herein.

To supplement the present disclosure, this application further incorporates entirely by reference the following commonly assigned patent applications:

| | U.S. pat- | | |
|---|---|---|---|
| | ent appli- | | |
| | cation | | |
| Docket Number | Ser. No. | Title | Filed On |
| 6070US1.014033.2138 | | MANAGED | Concurrently |
| | | DIGITAL | Herewith |
| | | WALLETS | |
| 6071US1.014033.2153 | | TOKEN COL- | Concurrently |
| | | LABORATION | Herewith |
| | | NETWORK | |
| 6071US2.014033.2154 | | FORMATION AND | Concurrently |
| | | FUNDING OF A | Herewith |
| | | SHARED TOKEN | |
| 6072US1.014033.2151 | | LIMITING TOKEN | Concurrently |
| | | COLLABORA- | Herewith |
| | | TION NETWORK | |
| | | USAGE BY USER | |
| 6072US2.014033.2152 | | LIMITING TOKEN | Concurrently |
| | | COLLABORA- | Herewith |
| | | TION NETWORK | |
| | | USAGE BY TOKEN | |
| 6073US1.014033.2149 | | LIMITING THE USE | Concurrently |
| | | OF A TOKEN | Herewith |
| | | BASED ON A | |
| | | USER LOCATION | |
| 6073US2.014033.2150 | | AUTHORIZING A | Concurrently |
| | | TEMPORARY | Herewith |
| | | TOKEN FOR | |
| | | A USER | |
| 6075US1.014033.2146 | | FLEXIBLE | Concurrently |
| | | FUNDING | Herewith |
| | | ACCOUNT TOKEN | |
| | | ASSOCIATIONS | |
| 6075US2.014033.2147 | | ACCOUNT TOKEN | Concurrently |
| | | ASSOCIATIONS | Herewith |
| | | BASED ON | |
| | | SPENDING | |
| | | THRESHOLDS | |
| 6076US1.014033.2144 | | ONLINE BANKING | Concurrently |
| | | DIGITAL WALLET | Herewith |
| | | MANAGEMENT | |
| 6076US2.014033.2145 | | CUSTOMER TOKEN | Concurrently |
| | | PREFERENCES | Herewith |
| | | INTERFACE | |
| 6076US3.014033.2172 | | CREDENTIAL | Concurrently |
| | | PAYMENT | Herewith |
| | | OBLIGATION | |
| | | VISIBILITY | |
| 6077US1.014033.2143 | | PROVIDING | Concurrently |
| | | SUPPLEMENTAL | Herewith |
| | | ACCOUNT | |
| | | INFORMATION IN | |
| | | DIGITAL WALLETS | |
| 6078US1.014033.2142 | | PROVIDING | Concurrently |
| | | OFFERS | Herewith |
| | | ASSOCIATED WITH | |
| | | PAYMENT | |
| | | CREDENTIALS IN | |
| | | DIGITAL WALLETS | |
| 6078US2.014033.2179 | | PROVIDING | Concurrently |
| | | OFFERS | Herewith |
| | | ASSOCIATED WITH | |
| | | PAYMENT | |
| | | CREDENTIALS | |
| | | AUTHENTICATED | |
| | | IN A SPECIFIC | |
| | | DIGITAL WALLET | |
| 6079US1.014033.2141 | | FOREIGN | Concurrently |
| | | EXCHANGE | Herewith |
| | | TOKEN | |
| 6079US2.014033.2173 | | FOREIGN CROSS- | Concurrently |
| | | ISSUED TOKEN | Herewith |
| 6080US1.014033.2140 | | DIGITAL WALLET | Concurrently |
| | | EXPOSURE | Herewith |
| | | REDUCTION | |
| 6080US2.014033.2174 | | MOBILE DEVICE | Concurrently |
| | | CREDENTIAL | Herewith |
| | | EXPOSURE | |
| | | REDUCTION | |
| 6081US1.014033.2139 | | ATM TOKEN CASH | Concurrently |
| | | WITHDRAWAL | Herewith |
| .US1.014033.002194 | | RESTORING OR | Concurrently |
| | | REISSUING OF | Herewith |
| | | A TOKEN | |
| | | BASED ON USER | |
| | | AUTHENTICATION | |
| .US1.014033.002195 | | TOKEN USAGE | Concurrently |
| | | SCALING BASED | Herewith |
| | | ON DETERMINED | |
| | | LEVEL OF | |
| | | EXPOSURE | |

What is claimed:

1. A system for controlling an issuance of a token in a token-based financial transaction system, whereby the system determines a potential level of exposure in a transaction for purposes of issuing a token with limited usage for authorizing the transaction, the system comprising:
a computer apparatus including one or more computing processors and a memory; and
a module stored in the memory, the module comprising computer-executable instructions that when executed by the one or more processors cause the system to:
receive information associated with a pending financial transaction involving a payment vehicle, wherein the information includes a token that is associated with the payment vehicle and that is used to obtain funds to pay for the pending financial transaction;
determine a potential exposure to loss in the pending financial transaction based at least partially on the information associated with the pending financial transaction;
in response to determining the potential exposure to loss, generate a limited token mitigating the potential exposure to loss prior to authorizing the pending financial transaction; and
authorize, using the limited token in lieu of the token, the pending financial transaction.

2. The system of claim 1, wherein the information associated with the pending financial transaction includes any one or more of: an amount of the pending financial transaction, identification of a payment vehicle, a previously issued token, an identification of one or more products and/or services, an identification of a merchant or parties involved in the pending financial transaction, and a geographic location of the pending financial transaction or the merchant.

3. The system of claim 1, wherein determining the potential exposure to loss comprises:
comparing the information associated with the financial transaction to one or more historical transaction patterns associated with the payment vehicle or a holder of the payment vehicle; and
determining that the pending financial transaction is an anomaly based at least partially on the comparison.

4. The system of claim 3, wherein an amount, location, frequency, or a combination thereof of the pending financial transaction is anomalous.

5. The system of claim 1, wherein the executable instructions further cause the processor to cancel a previously issued token associated with the pending financial transaction prior to generating the token.

6. The system of claim 5, wherein the generated token is different than the previously issued token, and wherein the generated token comprises instructions limiting the use of the generated token to any one or more of: transactions involving the merchant, transactions not exceeding a transaction amount, transactions in a geographic location, a limited number of financial transactions, one financial transaction, or any combination thereof.

7. The system of claim 1, wherein the executable instructions further cause the processor to provide to a holder of the payment vehicle a notification indicating a potential exposure to loss resulting from the pending financial transaction.

8. The system of claim 1, wherein the pending financial transaction, the determination of potential exposure to loss, and the automatic generation of a token occur in real-time or near real-time, as the pending financial transaction is being processed.

9. A computer program product for controlling an issuance of a token, the computer program product comprising a non-transitory computer-readable medium, wherein the non-transitory computer-readable medium comprises one or more computer-executable program code portions that, when executed by a computer, cause the computer to:
receive information associated with a pending financial transaction involving a payment vehicle, wherein the information includes a token that is associated with the payment vehicle and that is used to obtain funds to pay for the pending financial transaction;
determine a potential exposure to loss in the pending financial transaction based at least partially on the information associated with the pending financial transaction;
in response to determining the potential exposure to loss, generate a limited token mitigating the potential exposure to loss prior to authorizing the pending financial transaction; and
authorize, using the limited token in lieu of the token, the pending financial transaction.

10. The computer program product of claim 9, wherein the information associated with the pending financial transaction includes any one or more of: an amount of the pending financial transaction, identification of a payment vehicle, a previously issued token, an identification of one or more products and/or services, an identification of a merchant or parties involved in the financial transaction, and a geographic location of the pending financial transaction or the merchant.

11. The computer program product of claim 9, wherein determining the potential exposure to loss comprises:
comparing the information associated with the financial transaction to one or more historical transaction patterns associated with the payment vehicle or a holder of the payment vehicle; and
determining that the pending financial transaction is an anomaly based at least partially on the comparison.

12. The computer program product of claim 11, wherein an amount, location, frequency, or a combination thereof of the pending financial transaction is anomalous.

13. The computer program product of claim 9, wherein the computer program code further comprises one or more executable program portions that cause the computer to cancel a previously issued token associated with the pending financial transaction prior to generating the token.

14. The computer program product of claim 13, wherein the generated token is different than the previously issued token, and wherein the generated token comprises instructions limiting the use of the generated token to any one or more of: transactions involving the merchant, transactions not exceeding a transaction amount, transactions in a geographic location, a limited number of financial transactions, one financial transaction, or any combination thereof.

15. A method for controlling an issuance of a token, the method comprising:
receiving information associated with a pending financial transaction involving a payment vehicle, wherein the information includes a token that is associated with the payment vehicle and that is used to obtain funds to pay for the pending financial transaction;
determining, by a computer processor, a potential exposure to loss in the pending financial transaction based at least partially on the information associated with the pending financial transaction;
in response to determining the potential exposure to loss, generate a limited token mitigating the potential exposure to loss prior to authorizing the pending financial transaction; and
authorizing, using the limited token in lieu of the token, the pending financial transaction.

16. The method of claim 15, wherein the information associated with the pending financial transaction includes any one or more of: an amount of the pending financial transaction, identification of a payment vehicle, a previously issued token, an identification of one or more products and/or services, an identification of a merchant or parties involved in the financial transaction, and a geographic location of the pending financial transaction or the merchant.

17. The computer-implemented method of claim 15, wherein determining the potential exposure to loss comprises:
comparing the information associated with the financial transaction to one or more historical transaction patterns associated with the payment vehicle or a holder of the payment vehicle; and
determining that the pending financial transaction is an anomaly based at least partially on the comparison.

18. The computer-implemented method of claim 17, wherein an amount, location, frequency, or a combination thereof of the pending financial transaction is anomalous.

19. The method of claim 15, further comprises cancelling a previously issued token associated with the pending financial transaction prior to generating the token.

20. The method of claim 19, wherein the generated token is different than the previously issued token, and wherein the generated token comprises instructions limiting the use of the generated token to any one or more of: transactions involving the merchant, transactions not exceeding a transaction amount, transactions in a geographic location, a limited number of purchase transactions, one purchase transaction, or any combination thereof.
